(19) United States
(12) Patent Application Publication
(10) Pub. No.: US 2018/0114156 A1
(43) Pub. Date: Apr. 26, 2018

(54) COMPUTER-BASED AUTOMATIC TAGGING OF USER MULTIMEDIA DATA TO GENERATE COMMERCIAL SALES LEAD

(71) Applicants: Payam Zamani, Danville, CA (US); Saba Mirzaagha, Toronto (CA)

(72) Inventors: Payam Zamani, Danville, CA (US); Saba Mirzaagha, Toronto (CA)

(21) Appl. No.: 15/335,421

(22) Filed: Oct. 26, 2016

(51) Int. Cl. G06Q 10/06; G06Q 30/08; G06Q 30/02; G06F 17/27

(52) U.S. Cl. CPC G06Q 10/0631; G06Q 30/08; G06F 17/274; G06F 17/2705; G06F 17/278; G06Q 30/0201

(57) ABSTRACT

A system and a method are disclosed including a computer-implemented Automatic sales Lead Generation System (ALGS) configured to provide sales leads or information associated with customers or consumers (goods and services buyers) to merchants (lead buyers and goods and service providers), which offer goods and services to the customers. In various embodiments, an application server may receive multimedia data, including text, pictures, video clips, and voice data from a user to describe the user's service needs. Useful information may be extracted from the multimedia data automatically to generate sales leads of high relevance to a particular service category. The sales leads may be sent directly to service providers as hotlinks in an email or text message, or be posted on an leads exchange market for purchase by service providers. The sales leads may include user information, service information, timing information and other relevant information.

### CROSS-REFERENCE(S) TO RELATED APPLICATION(S)

This application is related to U.S. application Ser. No. 14/253,832, filed on 15 Apr. 2014, titled “COMPUTER-BASED COMMERCIAL MARKETPLACE SALES LEAD SCHEDULER”, the disclosure of which is hereby expressly incorporated by reference in its entirety.

### TECHNICAL FIELD

This patent application relates generally to sales leads. More specifically, this application relates to an automatic sales lead generation system that uses user-supplied multimedia data to categorize and generate sales leads.

### BRIEF DESCRIPTION OF THE DRAWINGS

The drawings, when considered in connection with the following description, are presented for the purpose of facilitating an understanding of the subject matter sought to be protected.

FIG. 1 shows an embodiment of a network computing environment wherein the disclosure may be practiced;

FIG. 2 shows an embodiment of a computing device that may be used in the network computing environment of FIG. 1;

FIG. 3 shows an example marketplace for trading commercial leads;

FIG. 4 shows an example computing environment for automatic lead generation based on multimedia data uploaded by a user;

FIG. 5 shows an example user data upload environment for uploading multimedia data by a user to request service;

FIG. 6 shows an example text parsing of a user's descriptions to categorize sales leads;

FIG. 7 shows an example text parsing of a user's descriptions to ascertain time-frame of services needed; and

FIG. 8 shows an example flow diagram of a method for automatically categorizing and generating sales lead for a leads market.

### DETAILED DESCRIPTION

While the present disclosure is described with reference to several illustrative embodiments described herein, it should be clear that the present disclosure should not be limited to such embodiments. Therefore, the description of the embodiments provided herein is illustrative of the present disclosure and should not limit the scope of the disclosure as claimed. In addition, while following description references services needed by a user and a web-based user interface, it will be appreciated that the disclosure may be used with other types of user needs such as goods and merchandise and other interfaces, such as application dialog boxes, server side windows, client side windows, and the like.

Briefly described, a system and a method are disclosed including a computer-implemented Automatic sales Lead Generation System (ALGS) configured to provide sales leads or information associated with customers or consumers (goods and services buyers) to merchants (lead buyers and goods and service providers), which offer goods and services to the customers. In various embodiments, an application server may receive multimedia data, including text, pictures, video clips, and voice data from a user to describe the user's service needs. Useful information may be extracted from the multimedia data automatically to generate sales leads of high relevance to a particular service category. The sales leads may be sent directly to service providers as hotlinks in an email or text message, or be posted on an leads exchange market for purchase by service providers. The sales leads may include user information, service information, timing information and other relevant information.

The commercial success of a business depends on customers that may be first identified and approached through customer leads, which include customer identifying and/or contact information, as well customer needs, preferences, profile, age, income level, previous purchase history, and the like. Lead information may take any form, including online information, lists, referrals, and the like. As such, leads are valuable commodities and assets usable for sales and marketing activities, which leads themselves may be bought and sold in a lead marketplace. The internet is a particularly suitable medium for exchanging leads, for example, in an online lead marketplace, because real-time updates and quick actions can take place more easily than in other environments. Efficiency and throughput of providing services depends on how relevant and accurate the leads are. Generating useful sales leads with adequate description and directed to the proper service providers enhances such efficiency and throughput by reducing the number poor referrals, which may not be relevant or be marginally relevant to a service provider's business. Such description may be obtained from the user by his direct and indirect descriptions.

### Illustrative Operating Environment

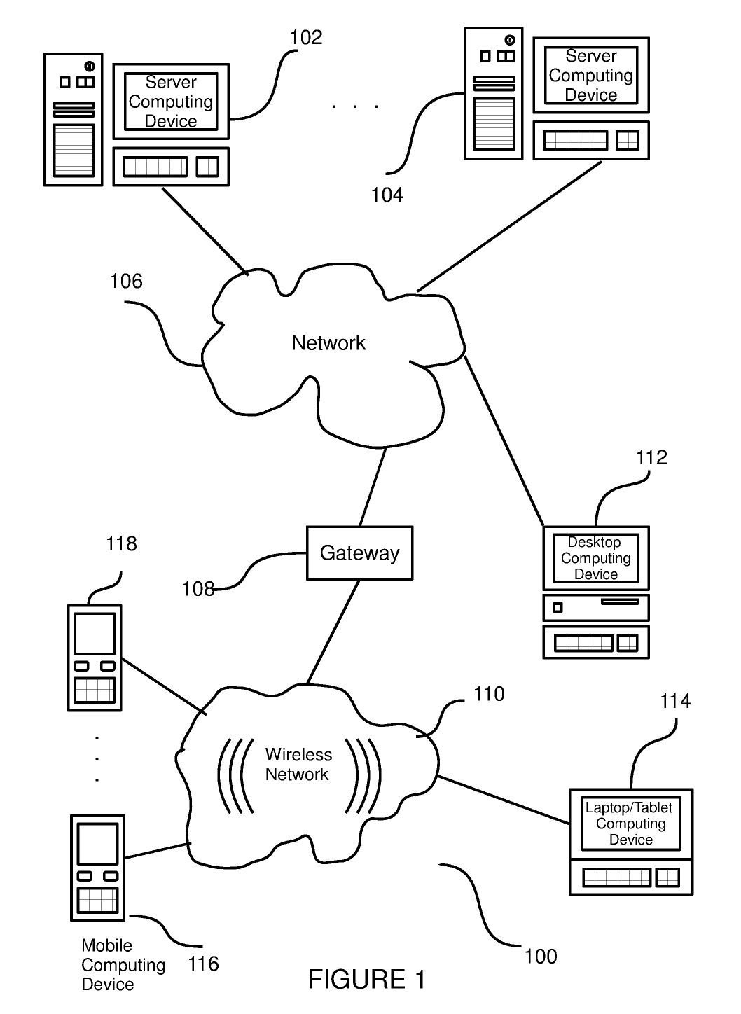

FIG. 1 shows components of an illustrative environment in which the disclosure may be practiced. Not all the shown components may be required to practice the disclosure, and variations in the arrangement and type of the components may be made without departing from the spirit or scope of the disclosure. System 100 may include Local Area Networks (LAN) and Wide Area Networks (WAN) shown collectively as Network 106, wireless network 110, gateway 108 configured to connect remote and/or different types of networks together, client computing devices 112-118, and server computing devices 102-104.

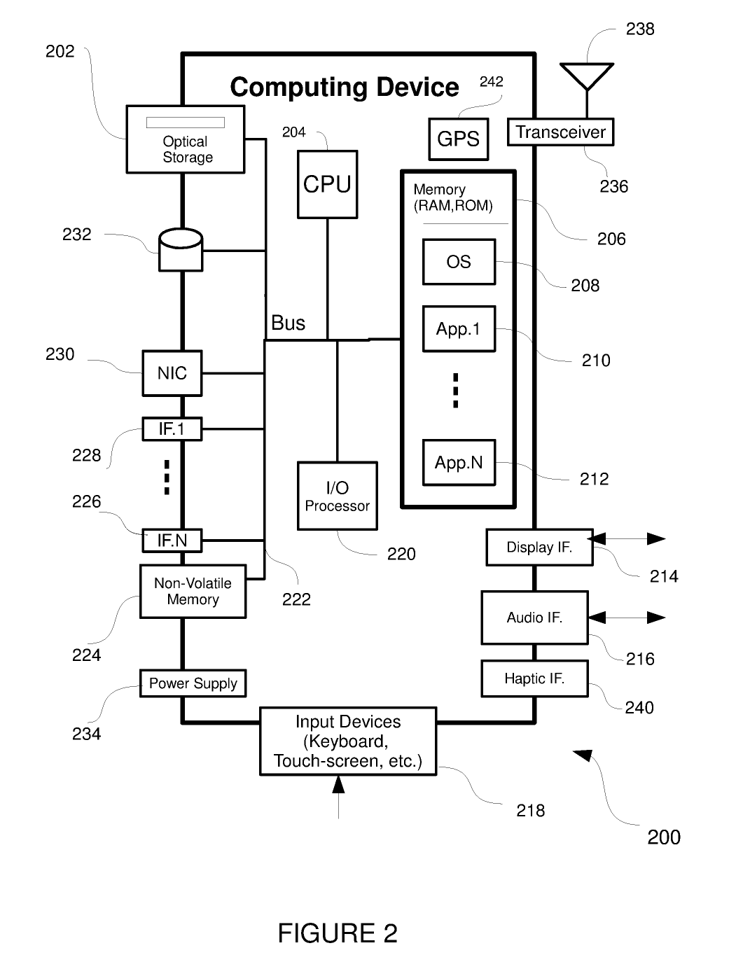

One embodiment of a computing device usable as one of client computing devices 112-118 is described in more detail below with respect to FIG. 2. Briefly, however, client computing devices 112-118 may include virtually any device capable of receiving and sending a message over a network, such as wireless network 110, or the like. Such devices include, but may not be limited to, portable devices such as, cellular telephones, smart phones, display pagers, radio frequency (RF) devices, music players, digital cameras, infrared (IR) devices, Personal Digital Assistants (PDAs), handheld computers, laptop computers, wearable computers, tablet computers, integrated devices combining one or more of the preceding devices, or the like. Client device 112 may include virtually any computing device that typically connects using a wired communications medium such as personal computers, multiprocessor systems, microprocessor-based or programmable consumer electronics, network PCs, or the like. In one embodiment, one or more of client devices 112-118 may also be configured to operate over a wired and/or a wireless network.

Client devices 112-118 typically range widely in terms of capabilities and features. For example, a cell phone may have a numeric keypad and a few lines of monochrome LCD display on which only text may be displayed. In another example, a web-enabled client device may have a touch sensitive screen, a stylus, and several lines of color LCD display in which both text and graphic may be displayed.

A web-enabled client device may include a browser application that is configured to receive and to send web pages, web-based messages, or the like. The browser application may be configured to receive and display graphic, text, multimedia, or the like, employing virtually any web based language, including a wireless application protocol messages (WAP), or the like. In one embodiment, the browser application may be enabled to employ one or more of Handheld Device Markup Language (HDML), Wireless Markup Language (WML), WMLScript, JavaScript, Standard Generalized Markup Language (SMGL), HyperText Markup Language (HTML), eXtensible Markup Language (XML), or the like, to display and send information.

Client computing devices 12-118 also may include at least one other client application that is configured to receive content from another computing device, including, without limit, server computing devices 102-104. The client application may include a capability to provide and receive textual content, multimedia information, or the like. The client application may further provide information that identifies itself, including a type, capability, name, or the like. In one embodiment, client devices 112-118 may uniquely identify themselves through any of a variety of mechanisms, including a phone number, Mobile Identification Number (MIN), an electronic serial number (ESN), mobile device identifier, network address, such as IP (Internet Protocol) address, Media Access Control (MAC) layer identifier, or other identifier. The identifier may be provided in a message, or the like, sent to another computing device.

Client computing devices 112-118 may also be configured to communicate a message, such as through email, Short Message Service (SMS), Multimedia Message Service (MMS), instant messaging (IM), internet relay chat (IRC), Mardam-Bey's IRC (mIRC), Jabber, or the like, to another computing device. However, the present disclosure is not limited to these message protocols, and virtually any other message protocol may be employed.

Client devices 112-118 may further be configured to include a client application that enables the user to log into a user account that may be managed by another computing device. Such user account, for example, may be configured to enable the user to receive emails, send/receive IM messages, SMS messages, access selected web pages, download scripts, applications, or a variety of other content, or perform a variety of other actions over a network. However, managing of messages or otherwise accessing and/or downloading content, may also be performed without logging into the user account. Thus, a user of client devices 112-118 may employ any of a variety of client applications to access content, read web pages, receive/send email and text messages, or the like. In one embodiment, for example, the user may employ a browser or other client application to access a web page hosted by a Web server implemented as server computing device 102. In one embodiment, messages received by client computing devices 112-118 may be saved in non-volatile memory, such as flash and/or PCM, across communication sessions and/or between power cycles of client computing devices 112-118.

Wireless network 110 may be configured to couple client devices 114-118 to network 106. Wireless network 110 may include any of a variety of wireless sub-networks that may further overlay stand-alone ad-hoc networks, and the like, to provide an infrastructure-oriented connection for client devices 114-118. Such sub-networks may include mesh networks, Wireless LAN (WLAN) networks, cellular networks, and the like. Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G) generation radio access for cellular systems, WLAN, Wireless Router (WR) mesh, and the like. Access technologies such as 2G, 3G, and future access networks may enable wide area coverage for mobile devices, such as client devices 114-118 with various degrees of mobility. For example, wireless network 110 may enable a radio connection through a radio network access such as Global System for Mobil communication (GSM), General Packet Radio Services (GPRS), Enhanced Data GSM Environment (EDGE), WEDGE, Bluetooth, High Speed Downlink Packet Access (HSDPA), Universal Mobile Telecommunications System (UMTS), Wi-Fi, Zigbee, Wideband Code Division Multiple Access (WCDMA), and the like. In essence, wireless network 110 may include virtually any wireless communication mechanism by which information may travel between client devices 102-104 and another computing device, network, and the like.

Network 106 is configured to couple one or more servers depicted in FIG. 1 as server computing devices 102-104 and their respective components with other computing devices, such as client device 112, and through wireless network 110 to client devices 114-118. Network 106 is enabled to employ any form of computer readable media for communicating information from one electronic device to another. Also, network 106 may include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another.

In various embodiments, the arrangement of system 100 includes components that may be used in and constitute various networked architectures. Such architectures may include peer-to-peer, client-server, two-tier, three-tier, or other multi-tier (n-tier) architectures, MVC (Model-View-Controller), and MVP (Model-View-Presenter) architectures among others. Each of these are briefly described below.

Peer to peer architecture entails use of protocols, such as P2PP (Peer To Peer Protocol), for collaborative, often symmetrical, and independent communication and data transfer between peer client computers without the use of a central server or related protocols.

Client-server architectures includes one or more servers and a number of clients which connect and communicate with the servers via certain predetermined protocols. For example, a client computer connecting to a web server via a browser and related protocols, such as HTTP, may be an example of a client-server architecture. The client-server architecture may also be viewed as a 2-tier architecture.

Two-tier, three-tier, and generally, n-tier architectures are those which separate and isolate distinct functions from each other by the use of well-defined hardware and/or software boundaries. An example of the two-tier architecture is the client-server architecture as already mentioned. In a 2-tier architecture, the presentation layer (or tier), which provides user interface, is separated from the data layer (or tier), which provides data contents. Business logic, which processes the data may be distributed between the two tiers.

A three-tier architecture, goes one step farther than the 2-tier architecture, in that it also provides a logic tier between the presentation tier and data tier to handle application data processing and logic. Business applications often fall in and are implemented in this layer.

MVC (Model-View-Controller) is a conceptually many-to-many architecture where the model, the view, and the controller entities may communicate directly with each other. This is in contrast with the 3-tier architecture in which only adjacent layers may communicate directly.

MVP (Model-View-Presenter) is a modification of the MVC model, in which the presenter entity is analogous to the middle layer of the 3-tier architecture and includes the applications and logic.

Communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. Network 106 may include any communication method by which information may travel between computing devices. Additionally, communication media typically may enable transmission of computer-readable instructions, data structures, program modules, or other types of content, virtually without limit. By way of example, communication media includes wired media such as twisted pair, coaxial cable, fiber optics, wave guides, and other wired media and wireless media such as acoustic, RF, infrared, and other wireless media.

### Illustrative Computing Device Configuration

FIG. 2 shows an illustrative computing device 200 that may represent any one of the server and/or client computing devices shown in FIG. 1. A computing device represented by computing device 200 may include less or more than all the components shown in FIG. 2 depending on the functionality needed. For example, a mobile computing device may include the transceiver 236 and antenna 238, while a server computing device 102 of FIG. 1 may not include these components. Those skilled in the art will appreciate that the scope of integration of components of computing device 200 may be different from what is shown. As such, some of the components of computing device 200 shown in FIG. 2 may be integrated together as one unit. For example, NIC 230 and transceiver 236 may be implemented as an integrated unit. Additionally, different functions of a single component may be separated and implemented across several components instead. For example, different functions of I/O processor 220 may be separated into two or more processing units.

With continued reference to FIG. 2, computing device 200 includes optical storage 202, Central Processing Unit (CPU) 204, memory module 206, display interface 214, audio interface 216, input devices 218, Input/Output (I/O) processor 220, bus 222, non-volatile memory 224, various other interfaces 226-228, Network Interface Card (NIC) 230, hard disk 232, power supply 234, transceiver 236, antenna 238, haptic interface 240, and Global Positioning System (GPS) unit 242. Memory module 206 may include software such as Operating System (OS) 208, and a variety of software application programs 210-212. Computing device 200 may also include other components not shown in FIG. 2. For example, computing device 200 may further include an illuminator (for example, a light), graphic interface, and portable storage media such as USB drives. Computing device 200 may also include other processing units, such as a math co-processor, graphics processor/accelerator, and a Digital Signal Processor (DSP).

Optical storage device 202 may include optical drives for using optical media, such as CD (Compact Disc), DVD (Digital Video Disc), and the like. Optical storage devices 202 may provide inexpensive ways for storing information for archival and/or distribution purposes.

Central Processing Unit (CPU) 204 may be the main processor for software program execution in computing device 200. CPU 204 may represent one or more processing units that obtain software instructions from memory module 206 and execute such instructions to carry out computations and/or transfer data between various sources and destinations of data, such as hard disk 232, I/O processor 220, display interface 214, input devices 218, non-volatile memory 224, and the like.

Memory module 206 may include RAM (Random Access Memory), ROM (Read Only Memory), and other storage means, mapped to one addressable memory space. Memory module 206 illustrates one of many types of computer storage media for storage of information such as computer readable instructions, data structures, program modules or other data. Memory module 206 may store a basic input/output system (BIOS) for controlling low-level operation of computing device 200. Memory module 206 may also store OS 208 for controlling the general operation of computing device 200. It will be appreciated that OS 208 may include a general-purpose operating system such as a version of UNIX, or LINUX™, or a specialized client-side and/or mobile communication operating system such as Windows Mobile™, Android®, or the Symbian® operating system. OS 208 may, in turn, include or interface with a Java virtual machine (JVM) module that enables control of hardware components and/or operating system operations via Java application programs.

Memory module 206 may further include one or more distinct areas (by address space and/or other means), which can be utilized by computing device 200 to store, among other things, applications and/or other data. For example, one area of memory module 206 may be set aside and employed to store information that describes various capabilities of computing device 200, a device identifier, and the like. Such identification information may then be provided to another device based on any of a variety of events, including being sent as part of a header during a communication, sent upon request, or the like. One common software application is a browser program that is generally used to send/receive information to/from a web server. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. However, any of a variety of other web based languages may also be employed. In one embodiment, using the browser application, a user may view an article or other content on a web page with one or more highlighted portions as target objects.

Display interface 214 may be coupled with a display unit (not shown), such as liquid crystal display (LCD), gas plasma, light emitting diode (LED), or any other type of display unit that may be used with computing device 200. Display units coupled with display interface 214 may also include a touch sensitive screen arranged to receive input from an object such as a stylus or a digit from a human hand. Display interface 214 may further include interface for other visual status indicators, such Light Emitting Diodes (LED), light arrays, and the like. Display interface 214 may include both hardware and software components. For example, display interface 214 may include a graphic accelerator for rendering graphic-intensive outputs on the display unit. In one embodiment, display interface 214 may include software and/or firmware components that work in conjunction with CPU 204 to render graphic output on the display unit.

Audio interface 216 is arranged to produce and receive audio signals such as the sound of a human voice. For example, audio interface 216 may be coupled to a speaker and microphone (not shown) to enable communication with a human operator, such as spoken commands, and/or generate an audio acknowledgement for some action.

Input devices 218 may include a variety of device types arranged to receive input from a user, such as a keyboard, a keypad, a mouse, a touchpad, a touch-screen (described with respect to display interface 214), a multi-touch screen, a microphone for spoken command input (describe with respect to audio interface 216), and the like.

I/O processor 220 is generally employed to handle transactions and communications with peripheral devices such as mass storage, network, input devices, display, and the like, which couple computing device 200 with the external world. In small, low power computing devices, such as some mobile devices, functions of the I/O processor 220 may be integrated with CPU 204 to reduce hardware cost and complexity. In one embodiment, I/O processor 220 may the primary software interface with all other device and/or hardware interfaces, such as optical storage 202, hard disk 232, interfaces 226-228, display interface 214, audio interface 216, and input devices 218.

An electrical bus 222 internal to computing device 200 may be used to couple various other hardware components, such as CPU 204, memory module 206, I/O processor 220, and the like, to each other for transferring data, instructions, status, and other similar information.

Non-volatile memory 224 may include memory built into computing device 200, or portable storage medium, such as USB drives that may include PCM arrays, flash memory including NOR and NAND flash, pluggable hard drive, and the like. In one embodiment, portable storage medium may behave similarly to a disk drive. In another embodiment, portable storage medium may present an interface different than a disk drive, for example, a read-only interface used for loading/supplying data and/or software.

Various other interfaces 226-228 may include other electrical and/or optical interfaces for connecting to various hardware peripheral devices and networks, such as IEEE 1394 also known as FireWire, Universal Serial Bus (USB), Small Computer Serial Interface (SCSI), parallel printer interface, Universal Synchronous Asynchronous Receiver Transmitter (USART), Video Graphics Array (VGA), Super VGA (SVGA), and the like.

Network Interface Card (NIC) 230 may include circuitry for coupling computing device 200 to one or more networks, and is generally constructed for use with one or more communication protocols and technologies including, but not limited to, Global System for Mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth, Wi-Fi, Zigbee, UMTS, HSDPA, WCDMA, WEDGE, or any of a variety of other wired and/or wireless communication protocols.

Hard disk 232 is generally used as a mass storage device for computing device 200. In one embodiment, hard disk 232 may be a Ferro-magnetic stack of one or more disks forming a disk drive embedded in or coupled to computing device 200. In another embodiment, hard drive 232 may be implemented as a solid-state device configured to behave as a disk drive, such as a flash-based hard drive. In yet another embodiment, hard drive 232 may be a remote storage accessible over network interface 230 or another interface 226, but acting as a local hard drive. Those skilled in the art will appreciate that other technologies and configurations may be used to present a hard drive interface and functionality to computing device 200 without departing from the spirit of the present disclosure.

Power supply 234 provides power to computing device 200. A rechargeable or non-rechargeable battery may be used to provide power. The power may also be provided by an external power source, such as an AC adapter or a powered docking cradle that supplements and/or recharges a battery.

Transceiver 236 generally represents transmitter/receiver circuits for wired and/or wireless transmission and receipt of electronic data. Transceiver 236 may be a stand-alone module or be integrated with other modules, such as NIC 230. Transceiver 236 may be coupled with one or more antennas for wireless transmission of information.

Antenna 238 is generally used for wireless transmission of information, for example, in conjunction with transceiver 236, NIC 230, and/or GPS 242. Antenna 238 may represent one or more different antennas that may be coupled with different devices and tuned to different carrier frequencies configured to communicate using corresponding protocols and/or networks. Antenna 238 may be of various types, such as omni-directional, dipole, slot, helical, and the like.

Haptic interface 240 is configured to provide tactile feedback to a user of computing device 200. For example, the haptic interface may be employed to vibrate computing device 200, or an input device coupled to computing device 200, such as a game controller, in a particular way when an event occurs, such as hitting an object with a car in a video game.

Global Positioning System (GPS) unit 242 can determine the physical coordinates of computing device 200 on the surface of the Earth, which typically outputs a location as latitude and longitude values. GPS unit 242 can also employ other geo-positioning mechanisms, including, but not limited to, triangulation, assisted GPS (AGPS), E-OTD, CI, SAI, ETA, BSS or the like, to further determine the physical location of computing device 200 on the surface of the Earth. It is understood that under different conditions, GPS unit 242 can determine a physical location within millimeters for computing device 200. In other cases, the determined physical location may be less precise, such as within a meter or significantly greater distances. In one embodiment, however, a mobile device represented by computing device 200 may, through other components, provide other information that may be employed to determine a physical location of the device, including for example, a MAC address.

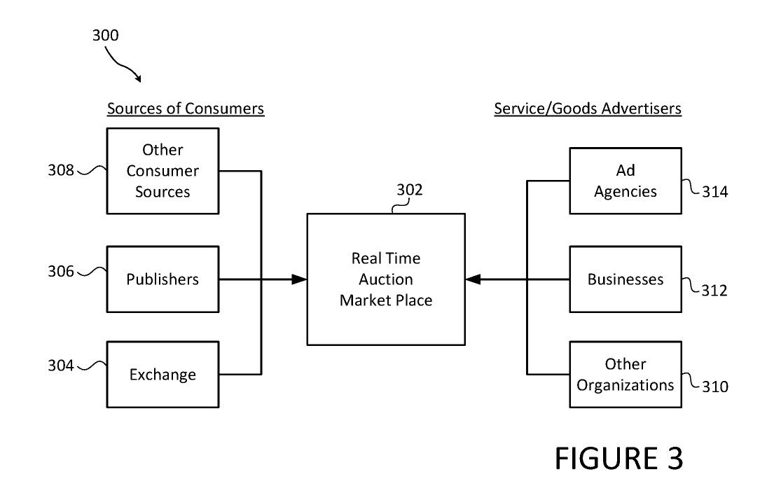

FIG. 3 shows an example marketplace for trading commercial leads. Marketplace 300 may include real time auction facility 302, sources of consumers including exchange boards 304, publishers 306, and other consumer sources 308; and service or product advertisers including advertising agencies 314, businesses 312, and other organizations 310.

In various embodiments, sales Lead Marketplace System (LMS) or auction facility 302 may be an online interface, such as a webpage, to which multiple users may log on to exchange sales leads. Generally, sales leads are potential customers for goods or services. Merchants are interested in obtaining a list of such potential customers to follow up and increase their sales volume. LMS 302 may thus be an electronic sales marketplace used to sell or buy sales leads for different industries, goods, or services. Service and/or good providers or advertisers are generally buyers of leads and sources of consumers are generally providers or sellers of consumer leads. For example, industry-specific exchanges such as contractor finding sites or other professional or commercial exchange sites may compile lists of highly relevant leads seriously looking for a specific types of goods or services, which may then be sold to other merchants in the same industry for follow-up. Similarly, publishers who publish and/or distribute advertisements may have access to highly relevant leads.

In various embodiments, the LMS provider may provide a user interface for accessing an electronic sales marketplace, obtaining sales leads, and going through the sales process in an orderly and timely manner to increase the utilization of the obtained leads. In some embodiments, the LMS is computer based and allows multiple merchants, advertisers, and generally lead buyers to log in and access the market. In other embodiments, the LMS provider may provide access to a private interface customized for a particular merchant by the LMS provider or a third party. In this embodiment, the merchant may be given the opportunity and computing facilities tailored to the merchant's business and practices and provide real time and/or aggregate data and statistics for its sales activities.

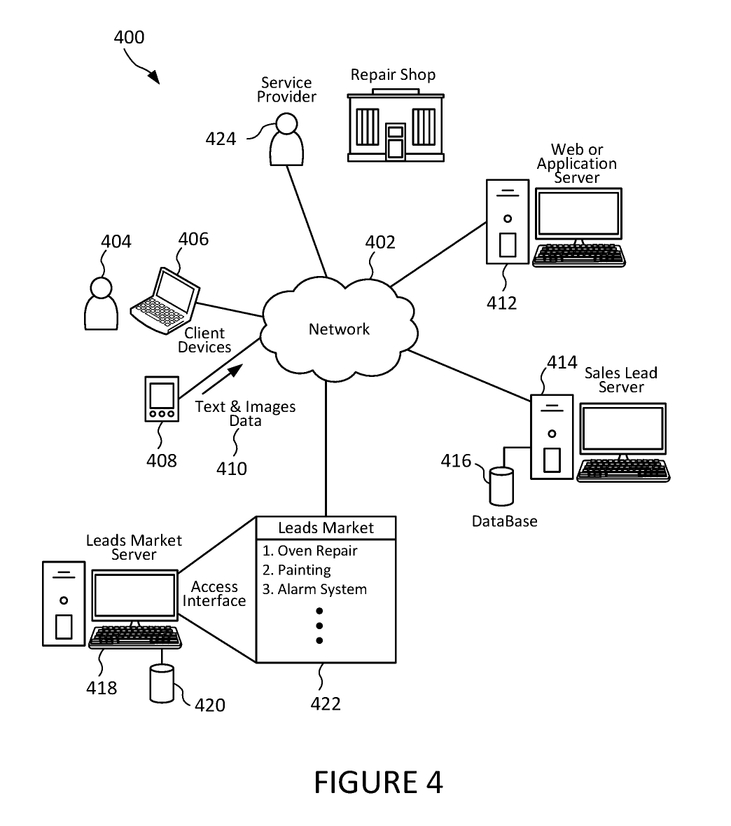

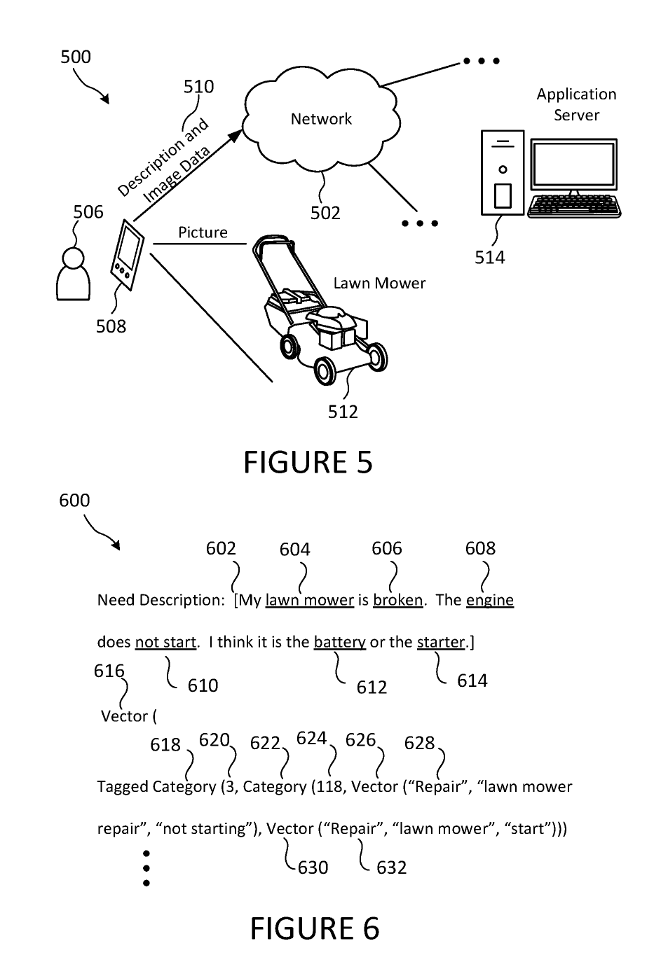

Once a lead is purchased or otherwise obtained by a merchant, it is desirable to quickly schedule a contact with the customer to further discuss customer needs or to schedule a time for the actual performance of the services the customer is interested in. Automatic lead generation from user-supplied multimedia data is further described with respect to FIGS. 4 and 5 below.

FIG. 4 shows an example computing environment for automatic lead generation based on multimedia data uploaded by a user. In various embodiments, Automatic Lead Generation system (ALGS) 400 includes a computer network 402, user 404, user client devices 406 and 408, multimedia data 410 uploaded by user to application server 412, sales leads server 414 and associated leads database 416, leads market server 418 and associated market server 420 to present market interface 422, and service provider 424.

In various embodiments, user 404 may be a customer looking for some services such as repairs, painting, gardening, house cleaning, home remodeling, legal advice, sports training, and the like. Client computing devices 406 and 408 may be substantially similar to those described with respect to FIGS. 1 and 2 above and are usable by the user to obtain and transmit multimedia data 410, for example, by recording pictures, video, and sound, and adding textual descriptions that describe his service needs.

In various embodiments, the ALGS may include one or more servers. In various embodiments, the ALGS may include servers such as web servers, application servers, message servers, email servers, database servers, marketing servers, back-end business servers, and the like. Three functions may be needed in ALGS and each function may be embedded in a separate computer server or one or more may be embedded in the same server. In some embodiments more or less than these three functions may be needed. These servers, whether one or more, are similar to those described above with respect to FIGS. 1 and 2. These functions include application service, sales lead service, and lead market service. Those skilled in the art will appreciate that servers may include a dedicated hardware platform or computer, or they may be implemented as software. Software servers may coexist on the same hardware platform with other software servers. Alternatively, hardware servers may be designed to perform only services defined for the particular server. For example, a communication server may include dedicated hardware for implementing communication protocols only and nothing else. On the contrary, a software server may include general purpose computer with server software installed on it. Such computer equipment may be repurposed by installing different software for other purposes. The ALGS may be owned and operated by third-party lead market operators distinct from the users and the service providers. Each of the users and the service providers may subscribe to the services of the market operators. Alternatively, they may go to a website operated by or associated with the market operators to request services (by users) or to buy sales leads (by service providers) to contact and serve the users.

In various embodiments, application server 412 may be a webserver to service web browser programs running on client computing devices, which may serve as user interface in a client-server computing model. In these embodiments, the application server 412 may include the backend functions to process user input used in sales lead generation. In other embodiments, the application server 412 may offer services and functionality via a corresponding client-side user-facing dedicated software application (unrelated to browsers) for this purpose. Examples of this kind of software application include Microsoft's® Remote Desktop Connection and TeamViewer™ are two such non-browser applications. In some embodiments, the services and functions provided by the application server include receiving multimedia data uploaded by the user, extracting user identification information, parsing textual user inputs to extract information about services needed by the user, analyzing scenes and extracting features from visual data such as pictures and video clips to extract further information about the needs of the user. Other functions of the application server may include using the extracted information to categorize and generate various leads for sale on the leads market. Alternatively, the generated leads may be transmitted directly to service providers who may be subscribers to a leads market service to be notified when appropriate leads become available. Such direct transmission may be by way of a hotlink in an email, text notification, alerts, or other common methods of notification and information sharing.

In various embodiments, a sales lead itself may be a data packet including various information such as user identification, contact information like phone number and email, user's service needs description and requirements, and other such information needed to fulfil the user's requested services. The lead data packet may further have a structure that is suitable for updates and sharing. For example, a lead may include a link or pointer to another data record, such as a file in file system or a record in a database, which may include the details. Those skilled in the art will appreciate that the lead data packet may have any suitable structure that allows recording and distribution of information in a controlled and secure manner.

In various embodiments, lead market server 414 may perform or complement some of the functions described above with respect to application server 412. For example, the lead server may acquire the information extracted by the application server about the user's needs and categorize and/or generate the lead. Those skilled in the art will appreciate that the various functions described herein may be performed by one or more software modules distributed over one or more servers. For example, the application server may categorize the information for the leads and the lead server may generate the actual leads information packets.

In various embodiments, a leads market 422 may be employed to buy and sell leads by market operators and service providers. Such market may operate as an exchange for purchasing transactions. In various embodiments, access to this exchange may be managed and controlled by the leads market server 418 coupled with a database 420 that may be used to maintain records of purchasing transactions on the market. The market operators may list various leads for purchase and service providers 424 may log on to their accounts on the exchange to purchase them. Those skilled in the art will appreciate that like any exchange market such as real estate or stock, a leads exchange market may be operated in a number of suitable known ways that require proper credentials to authorize access. Grant of such credentials may be based on the qualifications of the service providers to provide the appropriate services.

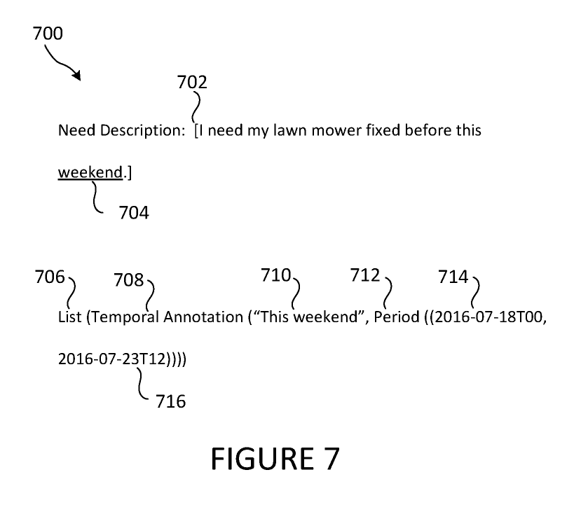

With continued reference to FIG. 4, in various embodiments, in operation, a user 404 may take a picture or video of a needed repair, for example, broken kitchen cabinets, that need repairs. The user may also record a voice clip to describe his needs with or without video. The user may then upload the data via a website interface or a standalone application to the application server 412. The application server may extract the necessary information from user data to categorize the services requested and generate leads for the user and the services he needs. The application server may then transmit the extracted data to the sales lead server 416 to use the data to categorize services and generate corresponding appropriate leads. This operation is further described with respect to FIGS. 6 and 7 below. Next, the sales lead server may post the generated leads to the market 422, which may maintain the lead information and other purchasing activities and transactions on database 420. As new users use the services of ALGS, new leads are added to the market in real time. The service providers 424 may also log into the leads market to view and purchase the leads they can service. Alternatively, the sales lead server may directly notify the service providers via various communication methods such as emails, texts, and the like. The notification may include a hotlink that provides access to the information about the lead such as description, expected price, time-frame of service, contact information, and the like.

In various embodiments, ALGS 400 and its components may be implemented by one or more hardware and/or software systems using one or more software components executing on the illustrative computing device of FIG. 2. One or more functions may be performed by each software module. For example one or more separate software components may be used for each of the functions to communicate with client devices and other servers in the system, uploading data, extracting features and keywords (textual or visual), categorizing service needs and leads, generating leads, posting leads to lead markets, interfacing with databases, presenting market interface, user and service provider registration and profile management, and any other function needed to carry out and implement the functions of the ALGS described herein. Those skilled in the art will appreciate that one function may implemented using multiple software modules or several functions may be implemented using one software module and the software modules may spread over one or more hardware platforms communicating with each other through various protocols. With reference to FIG. 2, these software modules are generally loaded into the memory module 206 of the computing device.

With continued reference to FIG. 4, in some embodiments, the information about the users and service providers may be used to create and/or update individual profiles that may be used to more efficiently service the users and the service providers. Part of the profiles' data may be a rating or grade for service providers to show their level of qualification for a given service type, customer satisfaction rating, reliability rating, and the like. Similarly, the users may have a rating in their profile that indicate how often they use services offered through the ALGS. Various rewards may be given that would encourage the use of the ALGS. These rewards may also be based on cumulative credit points earned by the users or service providers. The credit points may be awarded based on the scope of usage of the ALGS by the users or service providers.

FIG. 5 shows an example user data upload environment for uploading multimedia data by a user to request service. In various embodiments, user data upload environment 500 includes computer network, such as the Internet, 502, user 506, client mobile device 508, service need data 510, service subject 512, and application server 514.

In various embodiments, the user may take pictures and video, record sounds and voice, and write descriptions to be describe his service needs using user's own tools and methods that are familiar to him and convenient to use. For example, if the user has a lawn mower that is not working properly and wants to have it repaired, he may take a few pictures to show its model number and style, take a few video clips to show any irregularities and problems with how it operates, and record the sound the engine makes along with user voice comments. The user may also write some text to summarize the problem, the time-frame he needs the service, and other useful comments. The user may then upload such service data and information to the application server 514 via network 502 for processing.

As described above, in some embodiments, the application server, through software running thereon, may extract various information from the user-supplied data such as keywords from the text or images, visual features such as shapes and colors from images, words from spoken sounds, timing information from text or spoken data, contact information from text or image or spoken data, and the like. These various types of information may be subsequently used to categorize the services and/or corresponding leads later generated from the user service data. There may be several types or classes of information extracted from user description or other metadata included in the data uploaded by user. These types of extracted information may include information about the user, information about the services needed, and timing information. Any of these types of information may be extracted from one or more types of data such as text, visual and sound data. In some embodiments, each of these classes of information may be extracted by the same or a different software module.

In various embodiments, the first class of information are those about the user. This information may include the name of the user, contact information like phone number and email, service address, and other similar information directly related to a particular user. The first class of information may be extracted by a user information extraction software module.

In various embodiments, the second class of information are those about the services needed. This class of information may be extracted by a service information extraction software module. These are the information primarily used to categorize and generate leads. For example, if the words “lawn mower” and “repair” are parsed and extracted from the user's textual description or spoken words, or from analysis of a picture to recognize the shape of a lawn mower, then the service category associated with the lead may be “Repair of Machinery”, “Repair”, “Equipment Repair”, or other similar descriptive categories that identify the service area needed. If the words extracted included “cabinet” and “damage”, however, then the category assigned may be “Home Remodel”, “Cabinet Repair”, “Cabinet Upgrade”, “Home Installation”, or other similar appropriate categories. The categorization function may be performed by the application server or by the lead server or a combination of both, or by another server as appropriate for the particular design and implementation of the ALGS.

In some embodiments, the third class of information may be about the timing requirements, such as when service is needed or dependency between successive services, as further described herein. This class of information may be extracted by a timing information extraction software module. Two types of timing may be encountered. One is the time constraints on a particular service, and another is the dependency between multiple requested services. For example, if the user states in his description that the service is needed “before this weekend”, the timing extraction module may ascertain the current date or user's transmission date, determine the weekend date, and include this timing constraint information in the lead data packet. If the user has requested two interdependent services, then the software extraction module may determine the needed timing between the two services, prioritize them, and then create one or more sales leads with the appropriate timing information. For example, if the user has requested a kitchen cabinet upgrade and paint, each of the corresponding sales leads may be generated with the prioritized or sequential timing requirements so that the services can be provided in the appropriate and required order.

In various embodiments, the fourth class of information may be related to other matters than the first three classes, such as client device information, software versions, authentication of user and/or his client device, and the like. Such data may be extracted or generated from the metadata and other extracted information. This class of information may be extracted by a general information extraction software module.

In some embodiments, the multimedia data, including pictures, video and sound may be included in the lead data packet in original raw form so that the service provider can view and learn more in addition to the extracted data.

FIG. 6 shows an example text parsing of a user's descriptions to categorize sales leads. In various embodiments, parsing operation 600 of the application server may include a need description by 602 by the user having descriptive keywords 604, 606, 608, 610, 612, and 614 used to generate tagged category 618 having category identification 620, category name 622, recursive or nested vectors 626 and 630, having vector identification 624, and vector members 628 and 632.

In various embodiments, the description 602 supplied by the user is parsed to generate a tagged category including recursive vectors that successively break down the sentences into phrases, smaller phrases, and words that can be used to tag and categorize leads. The parsing may be used to extract nouns and verbs that may define the actions the user wants performed and the objects of those actions. For example, if the user description states “My lawn mower is broken”, then “lawn mower” is an extracted noun and “is broken” is an extracted verb. These two words at least partially indicate the object for which the service is being requested, that is, the lawn mower, and the type of work/service being requested to be performed, that is, repair. As another example, if the user description states “I need my fence painted”, then the parsing module may be used to determine that this request should be resolved in the painting category and should be assigned to exterior painting service providers.

FIG. 7 shows an example text parsing of a user's descriptions to ascertain time-frame of services needed. In various embodiments, parsing operation 700 of the application server may include a need description by 702 by the user having descriptive time-related keywords 704 used to generate list 706 having temporal annotation 708 with timing information 710, 712, 714, and 716.

In various embodiments, the description 702 supplied by the user is parsed to extract nouns, words, or phrases that are related to timing, such as “no later than”, “before”, “after”, “by”, “the 16^{th} of this month” and the like. Once the timing words are extracted, they may be compared with a calendar to derive exact service time-frame, such as earliest and latest service dates acceptable to be included in the aggregated lead data and/or leads data packets. Generally, aggregated lead data include the information gathered and/or extracted from various sources, including the user's request, description, attached files, user's profile, user's history, third party sources associated with the user, such as multimedia and social networks, and the like, that are associated with the user. Such aggregated data may be packaged into one or more data packets that may be associated or linked to each other. Such data packets may be treated as a unit of information for transmission between computers, and sending/receiving from data storage units and databases. The temporal annotation 708 may then associate the original timing word 710 with service commencement period defined by an earliest time 714 and a latest time 716. Temporal annotation 708 is used to generate list 706 to attribute a time requirement to the aggregated lead data. By a attributing a time requirement, temporal annotation qualifies to a service provider the timing of the work to be performed and to assess capacity to perform the service or address the consumer request.

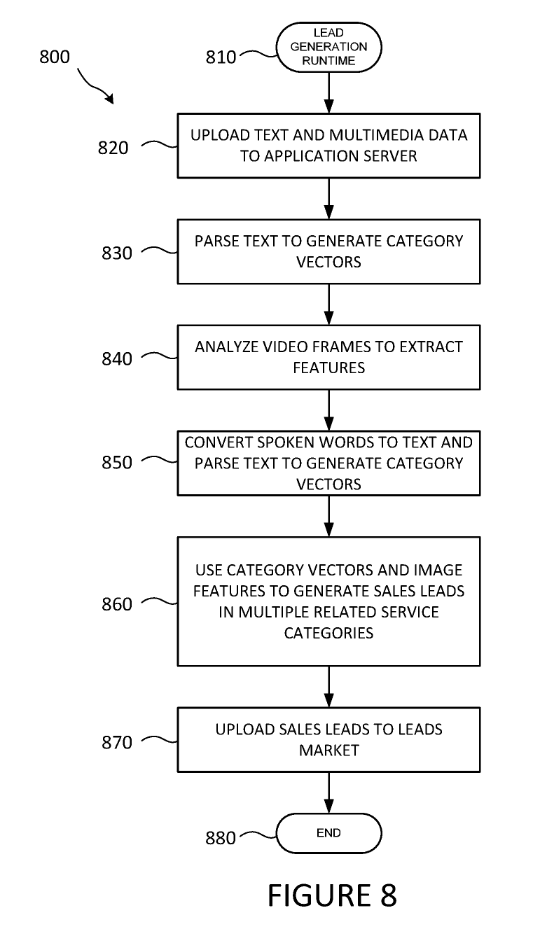

FIG. 8 shows an example flow diagram of a method for automatically categorizing and generating sales lead for a leads market. In various embodiments, the lead generation routine 800 starts at block 810 and proceeds to block 820. The details of the following process steps are described above throughout the specification with respect to various figures.

At block 820, a user uploads text and multimedia data including pictures, video and sound to the application server via a computer network. The routine proceeds to block 830.

At block 830 the multimedia data are parsed to generate category vectors as described above with respect to FIG. 6. The parsing may be done by the application server or software modules on other servers such as the lead server. The multimedia data may include text, pictures, video, and sound. The parsing process may be used to extract nouns, verbs, and timing words or phrases to be used in categorizing and generating leads and also indicate their required timing, if any. The routine proceeds to block 840.

At block 840, the visual data may be analyzed to extract features such as shape, text within the images, such as a model number on a machine, object recognition, such as a cracked chimney in a picture or video of a roof, and the like. Those skilled in the art will appreciate that many image analysis techniques may be used to extract features and recognize objects in an image. For example, edge following algorithms, Fourier analysis and filtering of signal frequencies in the image, and many other techniques, may be used in the analysis. Proceed to block 850.

At block 850, the sound data, if any, are analyzed. Transcription software modules for converting or transcribing spoken words into text may be used to extract spoken words. The transcribed text may then be further analyzed using the text parsing software module to extract nouns, verbs, or other words such as timing indicators to categorize leads. Category vectors may be generated based on all the extracted data from text and other data. The routine proceeds to block 860.

At block 860, the category vectors, and other extracted data are used to generated sales leads in various predefined categories. The sales leads may be associated with corresponding data packets and/or aggregated lead data including user name and contact information, service description, any timing requirements, and original multimedia data. Proceed to block 870.

At block 870, the generated leads are uploaded to the leads market or directly sent to service providers who are registered with the ALGS. Proceed to block 880.

At block 880, terminate the routine.

It will be further understood that unless explicitly stated or specified, the steps described in a process are not ordered and may not necessarily be performed or occur in the order described or depicted. For example, a step A in a process described prior to a step B in the same process, may actually be performed after step B. In other words, a collection of steps in a process for achieving an end-result may occur in any order unless otherwise stated.

Changes can be made to the claimed invention in light of the above Detailed Description. While the above description details certain embodiments of the invention and describes the best mode contemplated, no matter how detailed the above appears in text, the claimed invention can be practiced in many ways. Details of the system may vary considerably in its implementation details, while still being encompassed by the claimed invention disclosed herein.

Particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the claimed invention to the specific embodiments disclosed in the specification, unless the above Detailed Description section explicitly defines such terms. Accordingly, the actual scope of the claimed invention encompasses not only the disclosed embodiments, but also all equivalent ways of practicing or implementing the claimed invention.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” It is further understood that any phrase of the form “A/B” shall mean any one of “A”, “B”, “A or B”, or “A and B”. This construct includes the phrase “and/or” itself.

The above specification, examples, and data provide a complete description of the manufacture and use of the claimed invention. Since many embodiments of the claimed invention can be made without departing from the spirit and scope of the disclosure, the invention resides in the claims hereinafter appended. It is further understood that this disclosure is not limited to the disclosed embodiments, but is intended to cover various arrangements included within the spirit and scope of the broadest interpretation so as to encompass all such modifications and equivalent arrangements.

What is claimed is:

1. An Automatic sales Leads Generation System (ALGS) comprising:
An application computing device having software applications residing thereon and coupled to a computer network; and
a text parsing and analysis module coupled with the application computing device to parse and analyze textual service descriptions uploaded by a user via a client computing device to the application server to extract keywords usable in generating sales leads.

2. The system of claim 1, further comprising a sales lead computing device coupled to the computer network to generate the sales leads corresponding with the service descriptions.

3. The system of claim 1, further comprising a leads market computing device to receive and post sales leads from a sales lead computing device coupled with the computer network.

4. The system of claim 1, wherein the text parsing and analysis module is further usable to analyze multimedia information, including pictures, videos and sound to extract information related to service requests by the user to be used in leads generation.

5. The system of claim 1, wherein the keywords extracted include verbs and nouns that indicate a category of services needed by the user.

6. The system of claim 1, wherein the text parsing and analysis module is further usable to extract keywords in texts and recognize words in voice data that indicate a timing of services requested by the user.

7. The system of claim 1, wherein the generated sales leads are deliverable to multiple service providers via hotlinks to sales lead data.

8. The system of claim 1, wherein a leads market computing device is configured to receive the generated sales leads and make them available to service providers via a leads exchange market.

9. A method of providing services to customers, the method comprising:
receiving service description multimedia data uploaded by a user via computer network to an application computing device;
extracting information from the multimedia data to categorize services needed by the user;
generating sales leads corresponding to the services requested by the user based on the extracted information; and
making the sales leads available for purchase to service providers to provide the requested services.

10. The method of claim 9, further comprising categorizing services requested by the user based on the extracted information.

11. The method of claim 9, further comprising creating category vectors based on the extracted information.

12. The method of claim 9, wherein the extracting information from the multimedia data comprises parsing textual information to extract nouns and verbs that indicate the type of services needed by the user.

13. The method of claim 9, wherein the extracting information from the multimedia data comprises recognizing text and objects in visual data including pictures and video clips to identify services needed by the user.

14. The method of claim 9, wherein the generating sales leads comprises including aggregated data having sales lead user information, service information, and service timing information.

15. The method of claim 9, wherein the making the sales leads available comprises sending the sales leads to service providers directly as a hotlink in an email or text message.

16. A method of generating sales leads, the method comprising:
receiving service description multimedia data uploaded by a user via computer network to an application computing device;
extracting information from the multimedia data to categorize services needed by the user;
determining a time requirement of the services needed by the user; and
generating sales leads corresponding to the services requested by the user based on the extracted information and the time requirement for access by service providers.

17. The method of claim 16, further comprising creating category vectors based on the extracted information.

18. The method of claim 16, wherein the multimedia data include text, pictures, video clips, and voice data.

19. The method of claim 16, wherein determining a time requirement includes determining a start time and an end time when the service requested by the user are to be performed.

20. The method of claim 16, wherein access by service providers comprises using a sales leads exchange market to access posted sales leads.
